(19) United States
(12) Patent Application Publication
(10) Pub. No.: US 2006/0185696 A1
(43) Pub. Date: Aug. 24, 2006

(54) Substrate cleaning apparatus

(76) Inventor: Yoshiharu Yamamoto, Shiga (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/404,801

(22) Filed: Apr. 17, 2006

Related U.S. Application Data
(63) Continuation of application No. PCT/JP03/13351, filed on Oct. 20, 2003.

(51) Int. Cl. B08B 3/02

(52) U.S. Cl. 134/33; 134/34; 134/147; 134/158; 134/902; 134/198

(57) ABSTRACT

An inexpensive cleaning apparatus capable of exerting cleaning power on a side surface of a substrate at the same level as on a main surface thereof, and capable of changing an angle of a jetting device during cleaning without so changing a jet distance. The apparatus 1 comprise a table 10 for rotatably horizontally supporting the substrate 70, a jetting device 30 for jetting cleaning fluid onto the substrate, an arm 16 holding the device at the first end, and a shaft 17 holding the second end of the arm rotatably around a horizontal axis for guiding the arm in a horizontal direction, and is characterized in that the first end of the arm is positioned apart from an axis line of the second end when seen through the axis line of the second end.

This is a continuation of an International application No. PCT/JP03/13351 having an international filing date of Oct. 20, 2003.

### TECHNICAL FIELD

The present invention relates to a substrate cleaning apparatus, in particular, an apparatus suitably used for jetting cleaning fluid onto a semiconductor wafer or a substrate, such as a glass substrate for a liquid crystal display device, to clean the wafer or the substrate.

### BACKGROUND ART

A typical apparatus for cleaning a substrate is of a rotary type in which a substrate placed on a rotary table is rotated horizontally and, also, cleaning fluid such as pure water or chemical solution is jetted from a jetting device onto the substrate in order that the substrate is prevented from being cracked. The jetting device is generally provided with a jetting port at one end, a supersonic vibrator at the other end which is opposed to the one end, and a cleaning fluid supply port at a side face, so that supplied cleaning fluid can be supersonically vibrated with the supersonic vibrator to be jetted from the jetting port. The jetting device is fixed to an arm (also referred to as “bracket”), and the arm is connected to a vertical supporting shaft fixed in the vicinity of the table. The arm is rotated along with the rotation of the supporting shaft, and the jetting device turns around above and in parallel with the rotary table, to clean the entire main surface, from the center through the peripheral edge, of the substrate.

As the substrate cleaning apparatus of this rotary type, for example, Patent Document 1 has disclosed a structure that a bracket is provided with an arc-shaped guide that shifts a jetting device along with an imaginary circle with a rotating center of a substrate surface as the center within a plane including the rotating center and a jetting port. This can change an angle of the jetting device with respect to the substrate surface, and it is thereby possible to clean the rotating center of the substrate regardless of the thickness of the substrate surface or the kind of a contaminator.

Further, as shown in a plan view of FIG. 12 and a partially cutaway front view of FIG. 13, Patent Document 2 has disclosed a structure that an arm 45 is rotatably connected to a supporting shaft 52 in parallel with a rotary table 100, and a jetting device 40 is fixed to the front end of the arm 45. With this structure, it is possible to incline the jetting device 40 such that cleaning fluid is jetted with a jetting port 42 turned downward when the main surface of a substrate 70 is to be cleaned, and cleaning fluid is jetted in the direction which forms an angle with the side surface of the substrate 70 when the side surface of the substrate 70, that is the circumferential surface of the disc-shaped substrate 70, is to be cleaned.

[Patent Document 1] JP08-299918A

[Patent Document 2] WO02-54472A1

### DISCLOSURE OF THE INVENTION

However, in the apparatus described in Patent Document 1, sound pressure of the cleaning fluid applied to the side surface of the substrate has been considerably weak as compared with that of cleaning fluid jetted onto the main surface of the substrate since the angle of the jetting device cannot be changed during cleaning once determined according to the thickness of the substrate surface or the kind of a contaminant. Further, also in the apparatus described in Patent Document 2, a distance from the jetting port to a point of the substrate reached by the cleaning fluid (hereinafter, referred to as “jet distance”) is extended with a change in angle of the jetting device, and hence the sound pressure has been attenuated and cleaning power has decreased. Although it may be considered that the supporting shaft 52 is made extendable in the apparatus described in Patent Document 2 and the supporting shaft 52 is expanded or contracted according to the angle of the jetting device 40 so as to keep the jet distance constant, this would necessitate a source for driving expansion or contraction of the supporting shaft 52, which incurs a cost increase.

Accordingly, an object of the present invention is to provide a cleaning apparatus capable of exerting cleaning power on a side surface of a substrate at the same level as on a main surface thereof. Another object is to provide a cleaning apparatus at low cost which is capable of changing an angle of a jetting device during cleaning without greatly changing a jet distance.

In order to solve those problems, the cleaning apparatus of the present invention comprises a table, a jetting device, an arm and a guide. The table is for rotatably horizontally supporting a substrate. The jetting device is for jetting cleaning fluid onto the substrate. The arm holds the jetting device at a first end thereof. The guide holds a second end of the arm rotatably around a horizontal axis, for guiding the arm in a direction parallel with respect to the table. The first end of the arm is placed in a position apart from an axis line of the second end of the arm when seen through the axis line of the second end.

This arm's figuration can be realized for example by forming an angle of the arm with respect to the axis line or by bending the arm between the two ends such that a straight line connecting the first end and the second end does not agree with the axis line at the second end. Although a supporting shaft and a bearing, which allow the jetting device to turn around via the arm, are preferably cited as the guide as shown in a later-described embodiment, a rail or a ball screw may also be applied. The guide may directly hold the arm, or indirectly hold the arm via another arm.

The action of the apparatus is described along with drawings. The jetting device is capable of softly jetting in one direction, which for instance has the jetting port at one end and the supersonic vibrator at the other end which is opposed to the one end. FIG. 1 is a view of a positional relation between the jetting device and the substrate in the cleaning apparatus seen through the axis line of the arm. In the apparatus, since the straight line connecting the first end and the second end of the arm does not agree with the axis line at the second end, as shown in FIG. 1, a jetting device V is positioned away from a rotary shaft A of the arm, and is apart from the main surface of a substrate S by a jet distance d. The solid line in the figure shows the state of cleaning the main surface of the substrate S, and when the side surface is to be cleaned, as the imaginary line shows, the rotary shaft A rotates while horizontally shifting to the vicinity of the side surface. Therefore, even when the rotary shaft of the arm is not displaced in the vertical direction, the jetting device V descends to keep the jet distance at d.

One preferable configuration of the apparatus of the present invention is that the guide includes a supporting shaft and a bearing which allow the arm to rotate around a vertical axis, the arm has a bending point of one right angle between the first end and the second end, and the side surface of the jetting device is connected to the first end of the arm such that the centerline passing through the jetting port and the supersonic vibrator is orthogonal to the plane surface formed by the centerline of the arm.

Another preferable configuration is that the jetting device has a jetting port at one end and a supersonic vibrator at the other end, the guide includes a supporting shaft and a bearing which allow the arm to rotate around a vertical axis, the arm has bending points of two right angles which are in alternate angle relation to each other between the first end and the second end, and the side surface of the jetting device is connected to the first end of the arm such that the centerline passing through the jetting port and the supersonic vibrator is included in the plane surface formed by the centerline of the arm.

According to the cleaning apparatus of the present invention, since the angle of the jetting device can be changed during cleaning without greatly changing the jet distance, it is possible to exert cleaning power on the side surface of the substrate at the same level as on the main surface thereof, so as to clean the substrate thoroughly.

### BRIEF DESCRIPTION OF THE DRAWINGS

FIG. 1 is a view explaining an action of a cleaning apparatus of the present invention;

FIG. 2 is a partially cutaway plan view showing a cleaning apparatus of Embodiment 1;

FIG. 3 is a partially cutaway front view showing the cleaning apparatus of Embodiment 1;

FIG. 4 is a plan view showing a jetting device for use in the cleaning apparatus;

FIG. 5 is a front view showing the same;

FIG. 6 is also a front view showing an attitude of the jetting device with respect to the substrate at the time of shifting;

FIG. 7 is a plan view showing a cleaning device of Embodiment 2;

FIG. 8 is a partially cutaway front view showing the cleaning apparatus of Embodiment 2;

FIG. 9 is a plan view showing a jetting device for use in the cleaning apparatus;

FIG. 10 is a front view showing the same;

FIG. 11 is also a front view showing an attitude of the jetting device with respect to the substrate at the time of shifting;

FIG. 12 is a plan view showing a conventional cleaning apparatus;

FIG. 13 is a partially cutaway front view showing the conventional cleaning apparatus.

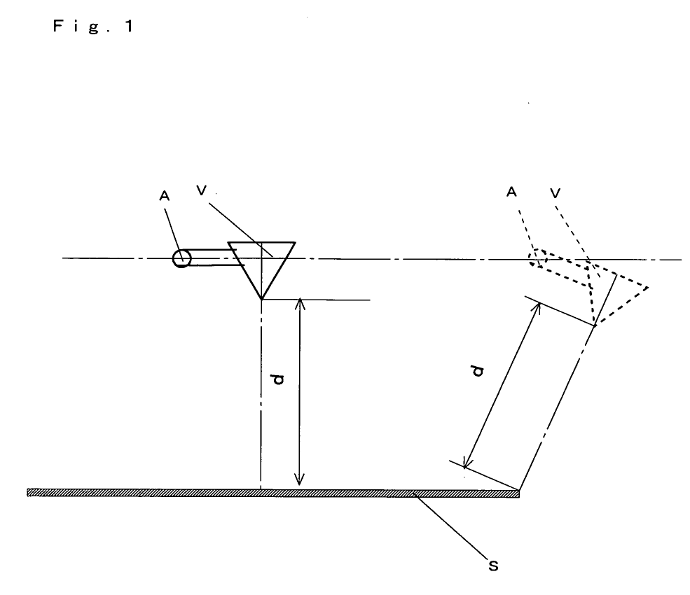

### BEST MODE FOR CARRYING OUT THE INVENTION

### Embodiment 1

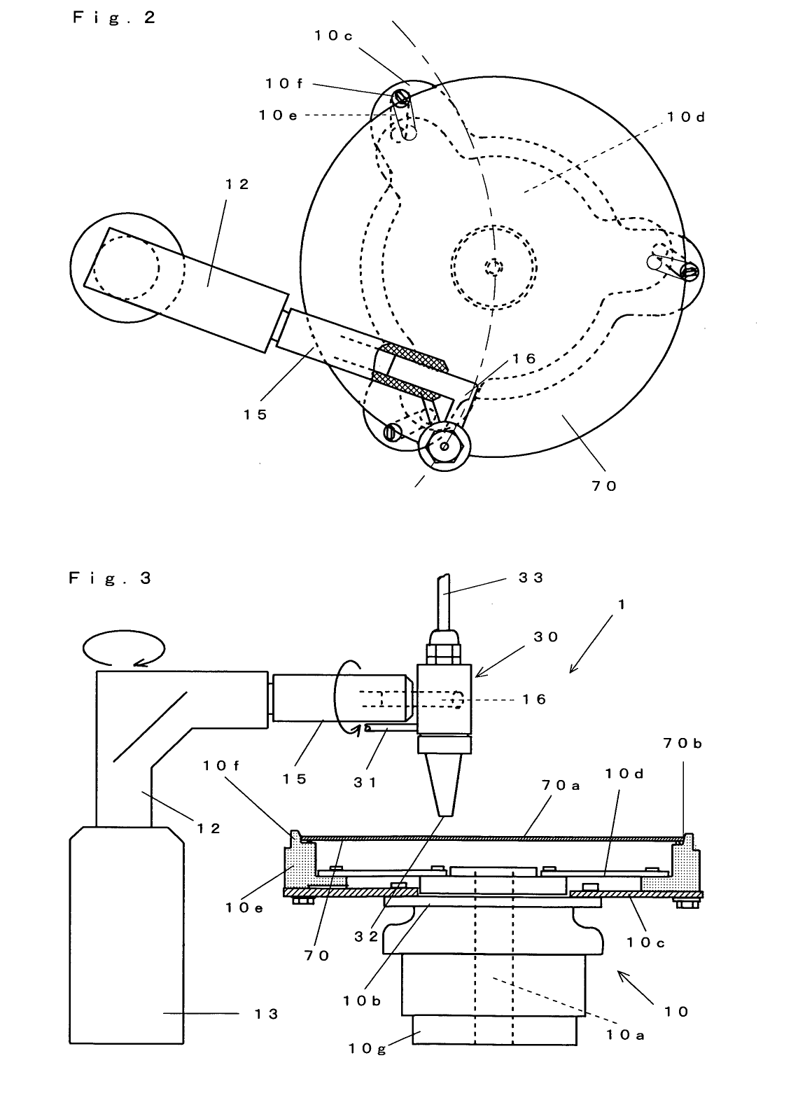

A first embodiment of the cleaning apparatus of the present invention is described along with drawings. FIG. 2 is a partially cutaway plan view showing the cleaning apparatus of the first embodiment. FIG. 3 is a partially cutaway front view showing the same.

A cleaning apparatus 1 cleans a substrate 70 while rotating it, and is equipped with a rotatable table 10 for horizontally supporting the substrate 70, a jetting device 30 for jetting cleaning fluid onto the substrate 70, and a reverse L-shaped supporting shaft 12 for turning the jetting device 30 around horizontally.

The table 10 is comprised of a rotary shaft 10a rotatably raised in a vertical direction within a leg 10g, a plate-like hub 10b fixed to the rotary shaft 10a, a plate-like collar 10c fixed onto the hub 10b, and a lock plate 10d fixed to the top of the rotary shaft 10a. The collar 10c forms a symmetrical shape in a plan view, including outwardly projecting sections respectively at three places in the peripheral direction. The lock plate 10d forms a shape similar to and smaller than the collar 10c. The projecting sections of the lock plate 10d are connected to the projecting sections of the collar 10c respectively by means of joints 10e L-shaped in the vertical section. These connecting sections are rotatable with respect to each other. Further, the lock plate 10d is rotatable with respect to both the rotary shaft 10a and the collar 10c via a bearing not shown in the figure. Therefore, although the lock plate 10d oscillates with respect to the collar 10c, the rotation angle thereof is restricted to a small amount by the joint 10e. A claw 10f is raised on the top of the joint 10e. The substrate 70 is detachably fixed to the claw 10f by oscillation of the lock plate 10d and the joint 10e.

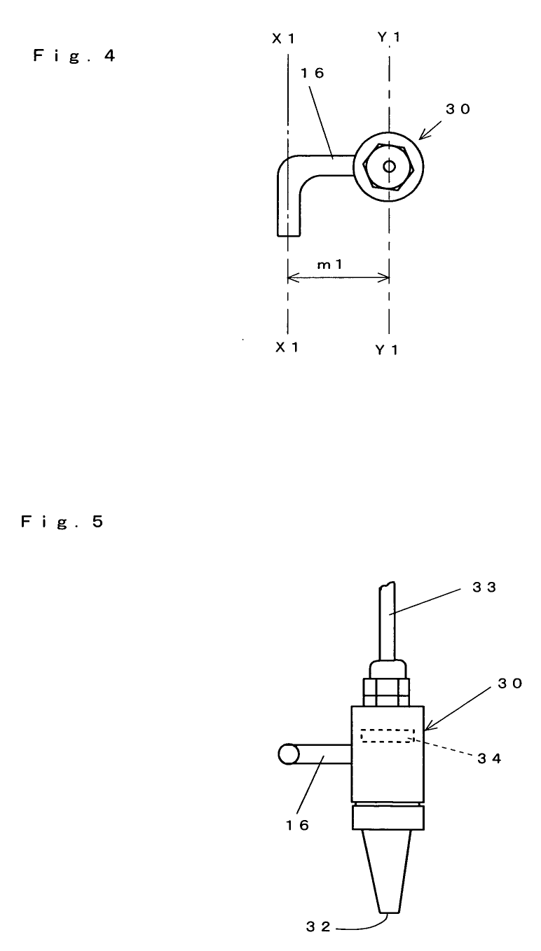

As shown in a plan view of FIG. 4 and a front view of FIG. 5, the jetting device 30 is positioned above the table 10, having a reverse frustum-shaped internal space which is tapered downward, and a jetting port 32 is formed at the bottom, while a cleaning fluid supply port (not shown) is formed on the side surface, to which the supply pipe 31 is connected. The top of the inside of the jetting device 30 which is opposed to the jetting port 32 is equipped with a supersonic vibrator 34. The supersonic vibrator 34 is excited by a voltage applied from an external power supply or the like through a wire 33 and vibrates, and thereby applies supersonic energy to liquid supplied from the supply pipe 31 when the liquid is jetted from the jetting port 32. The cleaning power is larger than that of a liquid emitted from a nonfrustum jetting device because the supersonic wave converges inside the reverse frustum.

The supporting shaft 12 is rotatably fixed around the vertical axis via a bearing 13 in the vicinity of the table 10, and connected to the output shaft of a motor, not shown in the figure. One end of a tubular first arm 15 is attached to the front end of a horizontally extending section of the top of the supporting shaft 12. Although the first arm 15 is partially overlapped over the table 10 in a plan view, the first arm 15 has a height sufficiently higher than the table 10 so as to prevent mutual interference during shifting. One end of a thin second arm 16 is fitted in the other end of the first arm 15. The second arm 16 forms an L-shape in a plan view as shown in FIGS. 2 and 4 and the tip end thereof is embedded in the side surface of the jetting device 30, so that the jetting device 30 is supported by the supporting shaft 12 via the first arm 15. Since the second arm 16 forms the L-shape, the axis center X1-X1 of the end of the second arm 16 fitted in the first arm 15 is separated from the axis center Y1-Y1 of the jetting device 30 by just a distance m1.

A procedure for cleaning the substrate 70 using the cleaning apparatus 1 is as follows. The lock plate 10d is rotated in the releasing direction (clockwise in FIG. 2), to gear three joints 10e. The claw 10f becomes parallel with a line in contact with a circle whose center is the rotary shaft 10a. The position of the joints 10e at that time is drawn by the imaginary line (thin solid line) in FIG. 2. The substrate 70 is placed on the upper surface of the joints 10e in a region surrounded by the inner periphery surfaces of the three claws 10f, and then the lock plate 10d is rotated in the locking direction (counter-clockwise in FIG. 2). The joints 10e return to a position drawn by the heavy dotted line, and the clockwise end of the claw 10f hits the side surface of the substrate 70 to restrain the substrate 70. In this state, cleaning is started. Rotations of the table 10, the supporting shaft 12 and the first arm 15 are controlled by a control circuit not shown in the figure.

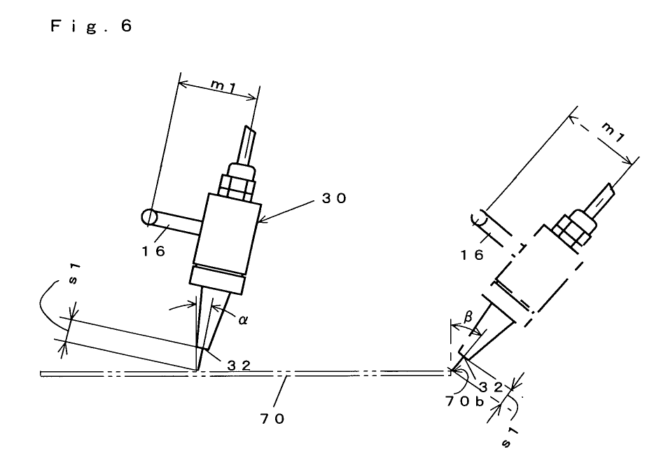

During cleaning, the jetting device 30 is displaced and changes its attitude as follows. First, cleaning fluid is jetted from the jetting port 32 toward the substrate 70 and the supporting shaft 12 rotates concurrently with rotation of the table 10 to turn the first arm 15 around. The jetting device 30 and the second arm 16 horizontally shift while being led by the first arm 15. While a main surface 70a of the substrate 70 is cleaned, the jetting device 30 is raised straight in the vertical direction or inclined slightly, i.e., only at an angle α in FIG. 6, as shown by the solid line in the figure. A jet distance is a length shown by S1. Next, when a side surface 70b of the substrate 70 is to be cleaned, as shown by the imaginary line in FIG. 6, the jetting port 32 is arranged out of the vertical projection range of the substrate 70, and the first arm 15 is rotated along with the second arm 16, whereby the jetting device 30 is inclined greatly, i.e., up to an angle β(α<β) in the direction that the top of the jetting device 30 moves away from the center of the substrate 70. The position of the jetting port 32 descends in the vertical direction and the jet distance is kept at S1.

As thus described, both in cleaning the main surface 70a of the substrate 70 and in cleaning the side surface 70b of the substrate 70, it is possible to keep the jet distance almost constant so as to clean the entire substrate with uniform cleaning power.

### Embodiment 2

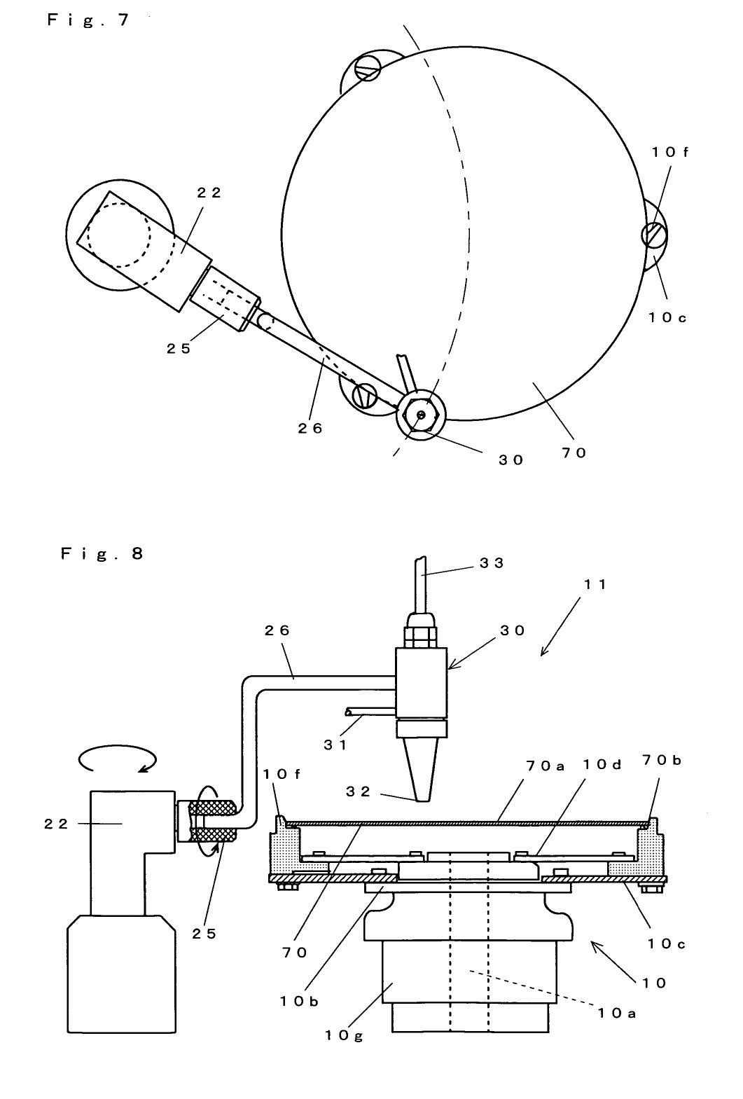

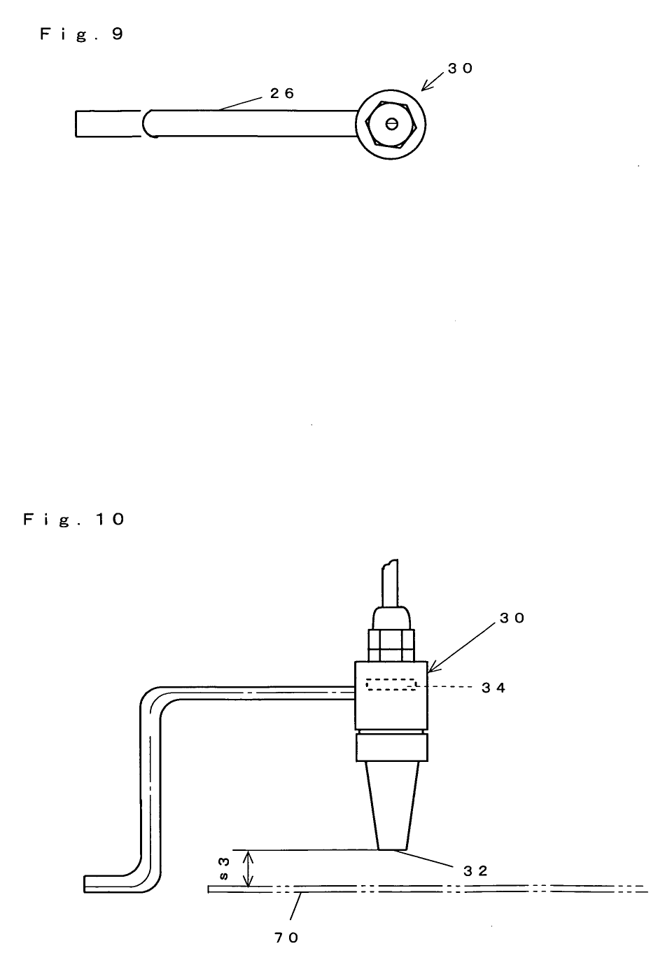

A second embodiment of the cleaning apparatus of the present invention is described along with drawings. FIG. 7 is a plan view showing a cleaning device of the second embodiment. FIG. 8 is a partially cutaway front view showing the same.

A cleaning apparatus 11 of this embodiment has the same shape and feature as those of the cleaning apparatus 1 of the first embodiment except that the shapes of a supporting shaft 22, a first arm 25 and a second arm 26 are different. Therefore, the same components as those of the first embodiment are just shown with the same numerals in the figures, and different points are described in details.

While the supporting shaft 22 is in reverse L-shape, it has a smaller height and a top with a shorter horizontal section than those in the first embodiment. The height of the centerline of the horizontal section is at the same level as that of the claw 10f. The first arm 25 is also short to an extent that it does not hit the table 10. On the other hand, as shown in FIGS. 8 and 10, the second arm 26 has bending points of two right angles which are in alternate angle relation to each other, after leaving the fitting section of the first arm 25, and is connected to the side surface of the jetting device 30 at the tip end thereof. The first bending point is positioned immediately after the section fitted with the first arm 25. The jetting device 30 is fixed such that a centerline passing through the jetting port 32 and a supersonic vibrator is included in a plane surface formed by a centerline of thickness of the second arm 26.

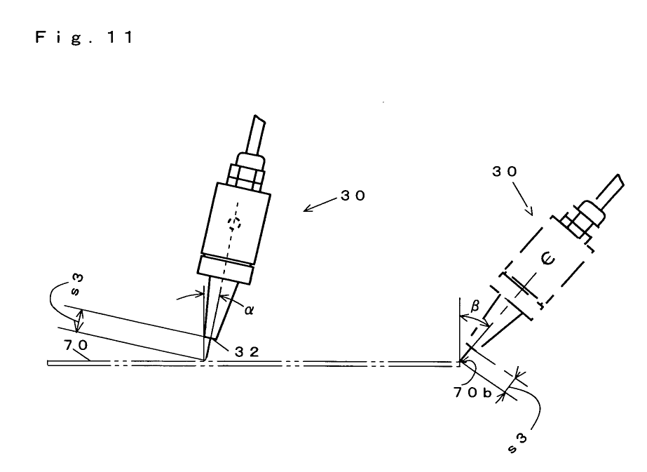

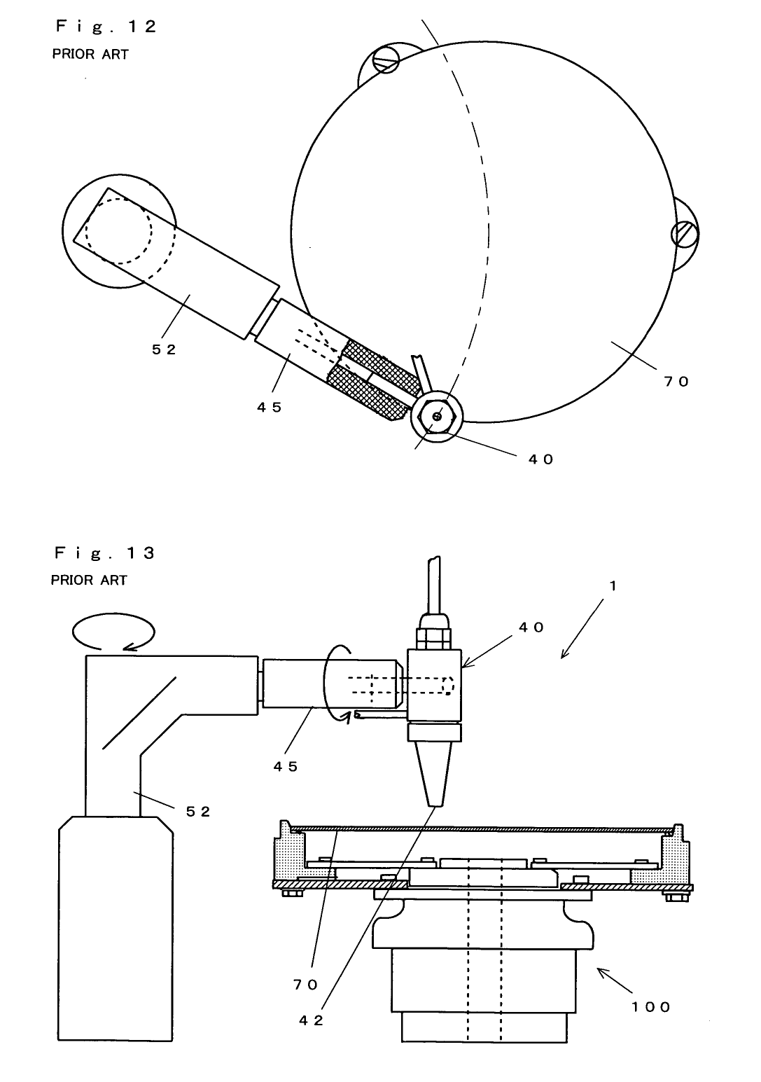

Also in this embodiment, during cleaning of the substrate 70, the jetting device 30 is displaced and changes its attitude as follows. First, cleaning fluid is jetted from the jetting port 32 toward the substrate 70, and the supporting shaft 22 rotates concurrently with rotation of the table 10 to turn the first arm 25 around. The jetting device 30 and the second arm 26 horizontally shift while being led by the first arm 25. While a main surface 70a of the substrate 70 is cleaned, the jetting device 30 is raised straight in the vertical direction or inclined slightly, i.e., only at an angle α, as shown by the solid line in FIG. 11. A jet distance is a length shown by S3. Next, when a side surface 70b of the substrate 70 is to be cleaned, as shown by the imaginary line in FIG. 11, the jetting port 32 is arranged out of the vertical projection range of the substrate 70, and the second arm 26 is rotated, whereby the jetting device 30 is inclined greatly, i.e., at an angle β(α<β) in the direction that the top of the jetting device 30 moves away from the center of the substrate 70. The position of the jetting port 32 descends in the vertical direction and the jet distance is kept at S3.

As thus described, both in cleaning the main surface 70a of the substrate 70 and in cleaning the side surface 70b of the substrate 70, it is possible to keep the jet distance almost constant so as to clean the entire substrate with uniform cleaning power.

### INDUSTRIAL APPLICABILITY

According to the cleaning apparatus of the present invention, both the main surface and the side surface of a thin substrate can be cleaned thoroughly, and the cleaning apparatus of the present invention is thus suitable for cleaning of a semiconductor wafer or a glass substrate for a liquid crystal display device.

What is claimed is:

1. An apparatus for cleaning a substrate, comprising:
a table for rotatably horizontally supporting a substrate;
a jetting device for jetting cleaning fluid onto the substrate;
an arm having a first and a second end and holding the jetting device at the first end, the first end being placed in a position apart from an axis line of the second end when seen through the axis line of the second end; and
a guide holding the second end of the arm rotatably around a horizontal axis for guiding the arm in a direction parallel with the table.

2. The apparatus according to claim 1, wherein
the jetting device has a jetting port at one end and a supersonic vibrator at the other end,
the guide includes a supporting shaft and a bearing which allow the arm to rotate around a vertical axis, and
the arm has a bending point of one right angle between the first and the second end, and holds the jetting device by connecting the side surface of the jetting device to the first end of the arm such that the centerline passing through the jetting port and the supersonic vibrator is orthogonal to the plane surface formed by the centerline of the arm.

3. The apparatus according to claim 1, wherein
the jetting device has a jetting port at one end and a supersonic vibrator at the other end,
the guide includes a supporting shaft and a bearing which allow the arm to rotate around a vertical axis, and
the arm has bending points of two right angles which are in alternate angle relation to each other between the first and the second end, and holds the jetting device by connecting the side surface of the jetting device to the first end of the arm such that the centerline passing through the jetting port and the supersonic vibrator is included in the plane surface formed by the centerline of the arm.

5. A method of jetting cleaning fluid from a jetting device, while rotating a substrate, to clean the substrate, the method comprising:
providing an arm having a first and a second end and holding the jetting device at the first end, the first end being placed in a position apart from an axis line of the second end when seen through the axis line of the second end, and a guide holding the second end of the arm rotatably around a horizontal axis and guiding the arm in a horizontal direction; and
rotating the arm to make the angle of the jetting device different between when the main surface of the substrate is to be cleaned and when the side surface thereof is to be cleaned.
